(19) United States
(12) Patent Application Publication
(10) Pub. No.: US 2025/0272626 A1
(43) Pub. Date: Aug. 28, 2025

(54) SCHEDULING APPARATUS, SCHEDULING METHOD, AND STORAGE MEDIUM

(71) Applicant: NEC Corporation, Minato-ku, Tokyo (JP)

(72) Inventor: Shinji ITO, Tokyo (JP)

(73) Assignee: NEC Corporation, Minato-ku, Tokyo (JP)

(21) Appl. No.: 18/862,195

(22) PCT Filed: May 18, 2022
(86) PCT No.: PCT/JP2022/020649

§ 371 Date: Nov. 1, 2024

(51) Int. Cl. G06Q 10/0631

(52) U.S. Cl. CPC G06Q 10/06311; G06Q 10/06313

(57) ABSTRACT

To provide a scheduling technique capable of scheduling a task requiring two or more rounds for completion of execution, a scheduling apparatus (1) includes: an obtaining section (11) that obtains an earned reward and a required round count of a task that completes execution in a round; and a selection section (12) that selects a combination of tasks each starting execution in a round with reference to the earned reward and the required round count obtained by the obtaining section (11). The selection section (12) divides a set of rounds into a plurality of blocks and selects the combination of tasks each starting execution in each of the rounds such that a combination of the same tasks is executed in each of rounds belonging to the same block.

### TECHNICAL FIELD

The present invention relates to a scheduling apparatus, a scheduling method, and a scheduling program for solving a combinatorial scheduling problem.

### BACKGROUND ART

To efficiently utilize various resources, a scheduling method for assigning appropriate resources to respective tasks at appropriate timings is required. For example, to efficiently utilize human resources in a workplace, a scheduling method for having each work performed by an appropriate worker at an appropriate timing is required.

An example of a document that discloses a scheduling method that uses a computer may be Non-Patent Literature 1. This Non-Patent Literature 1 discloses an algorithm for solving a semi-bandit type combinatorial scheduling problem.

### CITATION LIST

### Non-Patent Literature

B. Kveton, Z. Wen, A. Ashkan, and C. Szepesvari. Tight regret bounds for stochastic combinatorial semi-bandits. In Artificial Intelligence and Statistics, pages 535-543, 2015.

### SUMMARY OF INVENTION

### Technical Problem

However, in the scheduling method disclosed in Non-Patent Literature 1, only tasks each of which completes execution in a single round are taken into consideration. Therefore, a task which requires two or more rounds for completion of execution cannot be scheduled.

An example aspect of the present invention has been made in view of this problem, and an example object thereof is to provide a scheduling technique capable of scheduling a task requiring two or more rounds for completion of execution and capable of sufficiently increasing the sum of earned rewards.

### Solution to Problem

A scheduling apparatus in accordance with an example aspect of the present invention includes: obtaining means for obtaining an earned reward and a required round count of a task that completes execution in a round; and selection means for selecting a combination of tasks each starting execution in a round with reference to the earned reward and the required round count obtained by the obtaining means, the selection means dividing a set of rounds into a plurality of blocks and selecting the combination of tasks each starting execution in each of the rounds such that a combination of the same tasks is executed in each of rounds belonging to the same block.

A scheduling method in accordance with an example aspect of the present invention includes: an obtaining process of obtaining, by at least one processor, an earned reward and a required round count of a task that completes execution in a round; and a selection process of selecting, by the processor, a combination of tasks each starting execution in a round with reference to the earned reward and the required round count obtained in the obtaining process, in the selection process, the processor dividing a set of rounds into a plurality of blocks and selecting the combination of tasks each starting execution in each of the rounds such that a combination of the same tasks is executed in each of rounds belonging to the same block.

A scheduling program in accordance with an example aspect of the present invention is a scheduling program for causing a computer to operate as the scheduling apparatus, the program causing the computer to function as each of the means included in the scheduling apparatus.

### Advantageous Effects of Invention

According to the present invention, it is possible to provide a scheduling technique capable of scheduling a task requiring two or more rounds for completion of execution and capable of sufficiently increasing the sum of earned rewards.

### BRIEF DESCRIPTION OF DRAWINGS

FIG. 1 is a block diagram illustrating the configuration of a scheduling apparatus in accordance with an example embodiment.

FIG. 2 is a flowchart illustrating the flow of a scheduling method in accordance with an example embodiment.

FIG. 3 is a flowchart illustrating a specific example of a selection process included in the scheduling method illustrated in FIG. 2.

FIG. 4 is a block diagram illustrating the configuration of a computer functioning as the scheduling apparatus illustrated in FIG. 1.

### EXAMPLE EMBODIMENT

The following description will discuss an example embodiment of the present invention with reference to the drawings.

### [Combinatorial Scheduling Problem]

It is assumed that a set of tasks, [n]={1, 2, . . . , n}, and a set of combinations of tasks executable in parallel in the same round, A⊆2^{[n]}, are given. Here, 2^{[n]} represents the entirety of a subset of the set of tasks [n]. A problem of selecting a combination At of tasks each starting execution in each round t∈[T] so as to maximize the sum of earned rewards is referred to as a “combinatorial scheduling problem”. Here, it is assumed that the combination At of tasks each starting execution in each round t∈[T] satisfies the following Conditions 1 and 2.

At∩At′=Ø, Condition 1:

At∪At′∈A. Condition 2:

Here, At′ is a combination of tasks being in continued execution, and is defined as At′={i∈[n]|∃s<t, i∈As, s+cₛᵢ≥t}. Hereinafter, a set of task combinations each satisfying Conditions 1 and 2 above, {At⊆[n]|At∩At′=Ø, At∪At′∈A}, is referred to as a feasible region Ft.

Regarding task i∈[n] that starts execution in round t∈[T], a round count required for completion of execution of the task is denoted as the required round count c_{t,i}, and a reward earned after the completion of execution of the task is denoted as the earned reward rₜᵢ. Among the combinatorial scheduling problems, a problem in which the probability distribution D from which the pair (c_{t,i}, r_{t,i}) of the required round count c_{t,i} and the earned reward r_{t.i} follows is unknown, is referred to as a “bandit-type combinatorial scheduling problem”. Herein, such a bandit-type combinatorial scheduling problem will be discussed.

By solving the bandit-type combinatorial scheduling problem, it is possible to provide efficient scheduling in a situations in which it is difficult to estimate the required round count and the earned reward in advance, and there are constraints on the combination of tasks executable in parallel. Tasks to be dealt with are not particularly limited, and, for example, the following specific examples may be considered.

Specific Example 1 (scheduling in a computing machine): A problem of determining a combination of computational tasks to be executed in parallel at each timing (round) selected from among a set of computational tasks. In this case, for example, a set A of combinations of computational tasks executable in parallel may be determined based on constraints such as hardware resources (CPU, GPU, memory, etc.), which are responsible for the computational tasks, and power.

Specific Example 2 (scheduling in a workplace): A problem of determining a combination of work tasks to be executed in parallel at each timing (round) selected from among a set of work tasks. In this case, for example, a set A of combinations of work tasks executable in parallel may be determined based on constraints such as human resources (e.g., the number of workers, skills of each worker, etc.), which are responsible for the work tasks, and budgets.

Specific Example 3 (scheduling in a delivery network): A problem of determining a combination of delivery tasks to be executed in parallel at each timing (round) selected from among a set of delivery tasks. Here, each delivery task may be expressed as, for example, a pair of a delivery source and a delivery destination. In this case, for example, a set A of combinations of delivery tasks executable in parallel may be determined based on constraints such as the number of mobile objects (e.g., a track) responsible for delivery tasks, the supply volume of commodities supplied at each delivery source, the demand for commodities at each delivery destination.

Specific Example 4 (Scheduling in a factory or plant): A problem of determining a combination of manufacturing tasks to be executed in parallel at each timing (round) selected from among a set of manufacturing tasks (manufacturing processes). In this case, for example, a set A of combinations of manufacturing tasks executable in parallel may be determined based on constraints such as manufacturing facilities, which are responsible for the manufacturing tasks, and the execution order of manufacturing tasks.

In many cases, a set A of combinations of tasks executable in parallel in the same round is characterized by a polyhedron. That is, a certain matrix M∈R_{≥0}^{m×n} in which elements are nonnegative real numbers and a certain vector v ∈R_{≥0}^{m} in which elements are nonnegative real numbers are present, and a set P of indicator vectors each representing a combination of tasks executable in parallel in the same round is given by P={a∈{0,1}ⁿ|Ma≤v}. Here, an indicator vector representing a combination of tasks refers to a vector in which the i-th component is 1 if task i∈[n] is included in the combination, and the i-th component is 0 if task i∈[n] is not included in the combination.

For example, the following description will discuss a case where n tasks are executed with use of m resources. Assuming that a combination of resources required to execute each task i∈[n], which is denoted as Si⊆[m], and the maximum number of tasks each resource j∈[m] can be executed in parallel, which is denoted as vⱼ∈Z_{≥0}, are given as constraints, the set A of combinations of tasks executable in parallel in the same round is characterized by a polyhedron. Actually, a ji-th component Mⱼᵢ of the matrix M∈{0, 1}^{m×n} is defined as 1 if j∈Si, and otherwise 0. Further, the i-th component vi of the vector v∈{0,1}^{m} is defined as 1 if task i is being in execution, and otherwise 0. Then, an indicator vector a that represents a combination of tasks executable in parallel in the same round satisfies Ma≤v.

### [Configuration of Scheduling Apparatus]

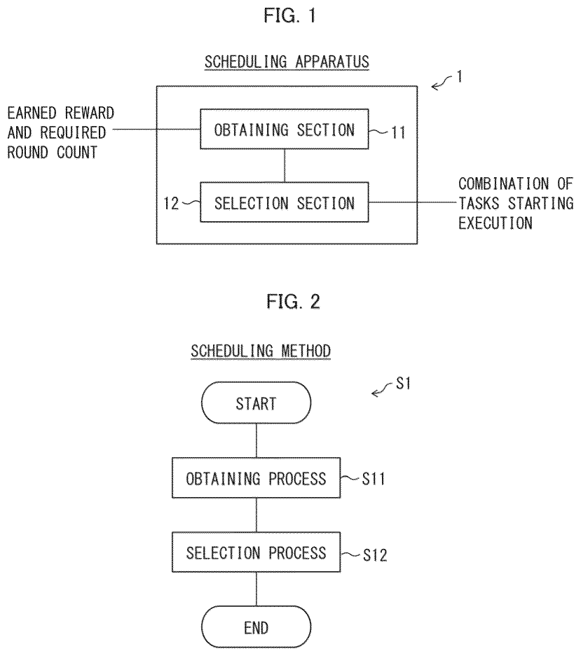

The configuration of a scheduling apparatus 1 in accordance with the present example embodiment will be described with reference to FIG. 1. FIG. 1 is a block diagram illustrating the configuration of the scheduling apparatus 1.

The scheduling apparatus 1 is an apparatus configured to solve the abovementioned bandit-type combinatorial scheduling problem, and includes an obtaining section 11 and a selection section 12, as illustrated in FIG. 1.

The obtaining section 11 is a means for obtaining, in each round t∈[T], for each task i∈[n] that has completed execution by the end of a round t−1, which is prior to the round t, a required round count ct′i and an earned reward rt′i of the task i. Here, t′ denotes a round in which task i starts execution.

The selection section 12 is a means for selecting, in each round t∈[T], a combination At of tasks each starting execution in the round t by referring to the required round count c_{t′i} and the earned reward r_{t′,i} obtained by the obtaining section 11 by the end of the round t−1, which is prior to the round t. The selection section 12 divides a set of the rounds, [T], into a plurality of blocks, and selects the combination At of tasks each starting execution in each round t∈[t] such that a combination of the same tasks is executed in each of rounds belonging to the same block.

By executing the combination of the same tasks in each of rounds belonging to the same block, it is possible to increase tasks executed in parallel in each round. Further, by selecting a combination of tasks to be executed for each block, it is possible to search for a combination of tasks with a large earned reward. Therefore, according to the scheduling apparatus 1, even if the probability distribution D from which the pair (c_{t,i}, r_{t,i}) of the required round count c_{t,i} and the earned reward r_{t,i} follows is unknown, the sum of earned rewards can be sufficiently increased.

### [Flow of Scheduling Method]

The flow of a scheduling method S1 in accordance with the present example embodiment will be described with reference to FIG. 2. FIG. 2 is a block diagram illustrating the flow of the scheduling method S1.

The scheduling method S1 is a method for solving the abovementioned bandit-type combinatorial scheduling problem. As illustrated in FIG. 2, the scheduling method S1 includes an obtaining process S11 and a selection process S12. In the present example embodiment, the scheduling method S1 is executed by the scheduling apparatus 1.

The obtaining process S11 is a process of obtaining, in each round t∈[T], for each task i∈[n] that has completed execution by the end of round t−1, which is prior to that round t, a required round count c_{t′,i} and an earned reward r_{t′,i} of the task i. Here, t′ denotes a round in which task i starts execution. In the present example embodiment, the obtaining process S11 is executed by the obtaining section 11 of the scheduling apparatus 1.

The selection process S12 is a process of selecting, in each round t∈[T], a combination At of tasks each starting execution in the round t by referring to the required round count c_{t′,i} and the earned reward r_{t′,i} obtained in the obtaining process S11 by the end of the round t−1, which is prior to the round t. In the present example embodiment, the selection process S12 is executed by the selection section 12 of the scheduling apparatus 1.

In the selection process S12, the selection section 12 divides a set of rounds, [T], into a plurality of blocks, and selects the combination At of tasks each starting execution in each round t∈[t] such that a combination of the same tasks is executed in each of rounds belonging to the same block.

By executing the combination of the same tasks in each of rounds belonging to the same block, it is possible to increase tasks executed in parallel in each round. Further, by selecting a combination of tasks to be executed for each block, it is possible to search for a combination of tasks with a large earned reward. Therefore, according to the scheduling method S1, even if the probability distribution D from which the pair (c_{t,i}, r_{t,i}) of the required round count c_{t,i} and the earned reward r_{t,i} follows is unknown, the sum of earned rewards can be sufficiently increased.

### [Specific Example of Selection Process]

It is assumed that a set of tasks [n], a set A of combinations of tasks executable in parallel in the same round, and the lower bound C₋ (in Table 1, − is written under C) and the upper bound C⁻ (in Table 1, − is written over C) of the required round count cₜᵢ of each task i∈[n] are given. In this case, the inventors have found that the following Algorithm 1 can sufficiently increase the sum of earned rewards. Here, sufficiently increasing the sum of earned rewards indicates that the regret R_{T} defined by R_{T}=E [(the sum of rewards earned by an optimal schedule in a case where the probability distribution D from which a pair (c_{t,i}, r_{t,i}) of the required round count cₜᵢ and the earned reward r_{t,i} follows is known)−(the sum of rewards earned by a schedule determined by Algorithm 1 shown in Table 1 below)] satisfies R_{T}=O(n(TlnT)^{1/2}). Here, E[⋅] denotes the expected value of ⋅.

```
TABLE 1
Algorithm 1 UCB-LCI based algorithm
Require: m the number of tasks, {Sᵢ} [symbol]  ⊆ 2^{|m|}: set of resources for tasks, C, C̅: lower and
  upper bounds for [symbol]
1: Set t = 1. For all i ∈ [n], set Nᵢ(1) = 0, Cᵢ(1) = 0, Rᵢ(1) = 0 for each i ∈ [n].
2: for s = 1, 2, . . . , do
3: for i = 1, 2, . . . , n do
4: If Nᵢ(1) = 0, set qᵢ(t) = 1/C. Otherwise, set
        $\text{?} ( \text{?} ) = \frac{{C}_{i} ( t )}{{N}_{i} ( t )} ,$
        $\text{?} ( t ) = \frac{{R}_{i} ( t )}{{N}_{i} ( t )} ,$
        ${d}_{i} ( t ) = \sqrt{\frac{2 log t}{{N}_{i} ( t )}} ,$
        ${q}_{i} ( t ) = \frac{{\hat{r}}_{i} ( t ) + {d}_{i} ( t )}{max ( \underline{C} , \text{?} ( t ) - \overline{C} {d}_{i} ( t ) \}} .$
5: end for
6: Set A′ₛ ∈ A and bₛ ≤ 1 by
                ${A}_{s}^{′} ∈ {arg max}_{A ∈ A} {\sum }_{i ∈ A} {q}_{i} ( t ) ,$
                ${b}_{s} = \underline{C} min \text{?} {N}_{i} ( t ) + \overline{C} ,$
7: for r = 1, 2, . . . , bₛ do
8: Choose the set of all available tasks in A′ₛ and output it.
9: For each i ∈ [n], if task i is released and [symbol]  and [symbol]  are observed ( [symbol]   stands for the last
      round the task i is assigned), update Nᵢ(t + 1) = Nᵢ(t) + 1, Cᵢ(t + 1) = Cᵢ(t) + [symbol]
      and Rᵢ(t + 1) = Rᵢ(t) + r [symbol]  . Otherwise, set Nᵢ(t + 1) = Nᵢ(t), Cᵢ(t + 1) = Cᵢ(t), and
      Rᵢ(t + 1) = Rᵢ(t).
10: Let t ← t + 1.
11: end for
12: end for [symbol]
indicates data missing or illegible when filed
```

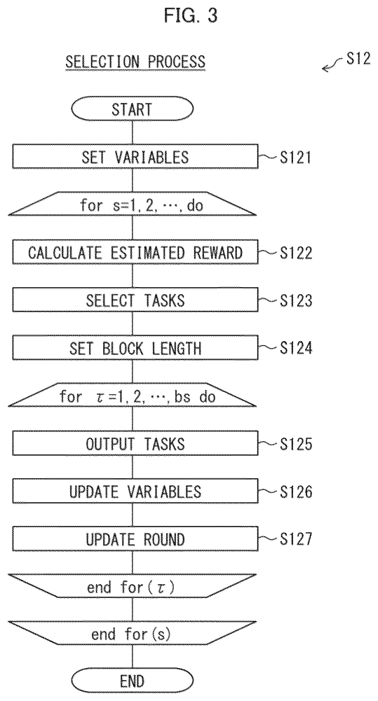

Hereunder, a specific example of the selection process S12, which is obtained by embodying this algorithm will be described with reference to FIG. 3. It should be noted that this algorithm is merely an example of the present example embodiment, and the present example embodiment should not be construed as being limited to this algorithm.

FIG. 3 is a flowchart illustrating a specific example of the selection process S12 in accordance with the present specific example. As illustrated in FIG. 3, the selection process S12 includes a variable setting step S121, an estimated reward calculation step S122, a task selection step S123, a block length setting step S124, a task output step S125, a variable update step S126, and a round update step S127. The estimated reward calculation step S122, the task selection step S123, and the block length setting step S124 are processes executed in the first round of each block. The task output step S125, the variable update step S126, and the round update step S127 are processes executed in each round of each block.

The variable setting step S121 is a step of carrying out initial settings of round number t, and variables Nᵢ(t), Cᵢ(t), and Rᵢ(t). In the variable setting step S121, the selection section 12 sets the round number t to t=1, and also sets the initial values Nᵢ(1), Cᵢ(1), and Rᵢ(1) of the variables Nᵢ(t), Cᵢ(t), and Rᵢ(t) to Nᵢ(1)=0, Cᵢ(1)=0, and Rᵢ(1)=0 for each task i∈[n].

Here, the variable Nᵢ(t) is a variable that represents the number of times the task i completes execution before or during the preceding block of a block to which the round t belongs. The variable Cᵢ(t) is a variable that represents the integrated value of the required round count of the task i up to the preceding block of the block to which the round t belongs. The variable Rᵢ(t) is a variable that represents the integrated value of the earned reward of the task i up to the preceding block of the block to which the round t belongs.

The estimated reward calculation step S122 is a step of calculating estimated reward qᵢ(t) of each task i∈[n]. Here, the estimated reward qᵢ represents the upper confidence bound (UCB) of an expected reward per round. In the estimated reward calculation step S122, the selection section 12 calculates the estimated reward qᵢ(t) of each task i∈[n] by using: the lower confidence bound (LCB) of an average required round count c\hat{ }ᵢ(t) (in Formula A1, \hat{ } is written over c) of the task i, and the upper confidence bound (UCB) of an average earned reward r\hat{ }i(t) (in Formula A1, \hat{ } is written over r) of the task i. For example, the selection section 12 may calculate the estimated reward qᵢ(t) of each task i∈[n] in accordance with qᵢ(t)=1/C₋ if Nᵢ(t)=0, and otherwise, the selection section 12 may calculate it in accordance with the following Formula (1).

$${\hat{c}}_{i} ( t ) = \frac{{C}_{i} ( t )}{{N}_{i} ( t )} , {\hat{r}}_{i} ( t ) = \frac{{R}_{i} ( t )}{{N}_{i} ( t )} , \\ {d}_{i} ( t ) = \sqrt{\frac{2 log t}{{N}_{i} ( t )}} , {q}_{i} ( t ) = \frac{{r}_{i} ( t ) + {d}_{i} ( t )}{max \{ {\underline{C}}_{i} {\hat{c}}_{i} ( t ) - \overline{C} {d}_{i} ( t ) \}} \qquad ( 1 )$$

The task selection step S123 is a step of selecting a combination As' of tasks to be executed in a block s. In task selection step S123, by referring to the estimated reward qᵢ(t) of each task i∈[n] calculated in the estimated reward calculation step S122, the selection section 12 selects the combination As' of tasks to be executed in the block s. For example, the selection section 12 may select the combination As' of tasks to be executed in the block s in accordance with Formula (2) below. That is, as the combination As' of tasks to be executed in the block s, the selection section 12 selects a combination of tasks that maximizes the sum of the estimated rewards qᵢ(t) from among combinations of tasks executable in parallel in the same round.

$${A}_{s}^{′} ∈ {arg max}_{A ∈ 𝒜} {\sum }_{i ∈ A} {q}_{i} ( t ) \qquad ( 2 )$$

The block length setting step S124 is a step of setting the block length bs of the block s. In the block length setting step S124, the selection section 12 calculates the block length bs of the block s by using the lower bound C₋ and the upper bound C⁻ of the required round count cₜᵢ of each task i∈[n]. For example, the selection section 12 may set the block length bs of the block s in accordance with the following Formula (3).

$${b}_{s} = \underline{C} {min}_{i ∈ {A}_{s}^{′}} {N}_{i} ( t ) + \overline{C} \qquad ( 3 )$$

The task output step S125 is a step of outputting the combination At of tasks that newly start execution in the round t as a result of the selection process S12. In the task output step S125, the selection section 12 outputs, as the combination At of tasks newly starting execution in the round t, a combination of all available tasks (all tasks that are not in continued execution) out of tasks included in the combination As' of tasks selected in the task selection step S123.

The variable update step S126 is a step of updating the variables Nᵢ(t), Cᵢ(t), and Rᵢ(t). In the variable update step S126, the selection section 12 updates the variables Nᵢ(t), Cᵢ(t), and Rᵢ(t), by referring to the required round count c_{t′,i} and the earned reward r_{t,i} obtained in the obtaining process S11. For example, the selection section 12 may update the variables Nᵢ(t), Cᵢ(t), and Rᵢ(t) in accordance with Nᵢ(t+1)=Nᵢ(t)+1, Cᵢ(t+1)=Cᵢ(t)+ct′,i, and Rᵢ(t+1)=Rᵢ(t)+rt′,i. If there is no task that completes execution in the round t, the selection section 12 updates the variables Nᵢ(t), Cᵢ(t), and Rᵢ(t) in accordance with Nᵢ(t+1)=Nᵢ(t), Cᵢ(t+1)=Cᵢ(t), and Rᵢ(t+1)=Rᵢ(t).

The round update step S127 is a step of updating the round t to be processed. In the round update step S127, the selection section 12 increments the round t to be processed by 1 (t←t+1).

According to the selection process S12 illustrated in FIG. 3, the regret R_{T} defined by the R_{T}=E[(the sum of rewards earned by an optimal schedule in a case where the probability distribution D from which a pair (c_{t,i}, r_{t,i}) of the required round count c_{t,i} and the earned reward r_{t,i} follows is known)−(the sum of rewards earned by a schedule determined by Algorithm 1 shown in Table 1 below)] can be inhibited to O(n(TlnT)^{1/2}).

### [Software Implementation Example]

Some or all of the functions of the scheduling apparatus 1 may be implemented by hardware such as an integrated circuit (IC chip), or may be alternatively implemented by software. In the latter case, the function of each section of the scheduling apparatus 1 is implemented by, for example, a computer that executes instructions of a program that is software.

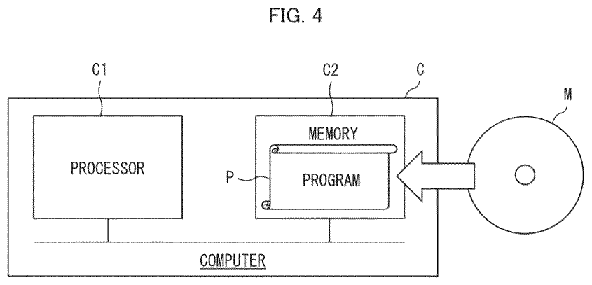

FIG. 4 illustrates an example of such a computer (hereinafter, referred to as “computer C”). As illustrated in FIG. 4, the computer C includes at least one processor C1 and at least one memory C2. The memory C2 stores a program P for causing the computer C to operate as the scheduling apparatus 1. The processor C1 of the computer C retrieves the program P from the memory C2 and executes the program P, so that the function of each section of the scheduling apparatus 1 is implemented.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination of these.

Note that the computer C may further include a random access memory (RAM) in which the program P is loaded in execution of the program P and/or in which various kinds of data are temporarily stored. The computer C may further include a communication interface via which data is transmitted to and received from another apparatus. The computer C may further include an input/output interface for connecting input apparatuses such as a keyboard and a mouse, and/or output apparatuses such a display and/or a printer.

The program P can be recorded in a non-transitory tangible storage medium M from which the computer C can read the program P. The storage medium M can be, for example, a tape, a disk, a card, a semiconductor memory, a programmable logic circuit, or the like. The computer C can acquire the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. Note, however, that the present invention is not limited to the following supplementary notes.

### (Supplementary Note 1)

A scheduling apparatus including: obtaining means for obtaining an earned reward and a required round count of a task that completes execution in a round; and
selection means for selecting a combination of tasks each starting execution in a round with reference to the earned reward and the required round count obtained by the obtaining means,
the selection means dividing a set of rounds into a plurality of blocks and selecting the combination of tasks each starting execution in each of the rounds such that a combination of the same tasks is executed in each of rounds belonging to the same block.

### (Supplementary Note 2)

The scheduling apparatus according to Supplementary note 1, wherein, for each block, the selection means (i) calculates an estimated reward of each task by using a lower confidence bound (LCB) of an average required round count of the task and an upper confidence bound (UCB) of an average earned reward of the task, and (ii) selects a combination of tasks that maximizes a sum of estimated rewards of the tasks, from among combinations of tasks executable in parallel in the same round, as a combination of tasks to be executed in the block.

### (Supplementary Note 3)

The scheduling apparatus according to Supplementary note 2, wherein, for each block s, the selection means (i) calculates an estimated reward qᵢ(t) of each task i in accordance with the following Formula (1), and (ii) selects a combination A's of tasks to be executed in the block s in accordance with the following Formula (2):

$${\hat{c}}_{i} ( t ) = \frac{{C}_{i} ( t )}{{N}_{i} ( t )} , {\hat{r}}_{i} ( t ) = \frac{{R}_{i} ( t )}{{N}_{i} ( t )} , \\ {d}_{i} ( t ) = \sqrt{\frac{2 log t}{{N}_{i} ( t )}} , {q}_{i} ( t ) = \frac{{r}_{i} ( t ) + {d}_{i} ( t )}{max \{ {\underline{C}}_{i} {\hat{c}}_{i} ( t ) - \overline{C} {d}_{i} ( t ) \}} \qquad ( 1 )$$

in which C₋ (in Formula (1), − is written under C) denotes a lower bound of a required round count of the task i, C⁻ (in Formula (1), − is written over C) denotes an upper bound of the required round count of the task i, Nᵢ(t) denotes the number of times the task i completes execution before or during a preceding block of a block to which a round t belongs, Cᵢ(t) denotes an integrated value of the required round count of the task i up to the preceding block of the block to which the round t belongs, Rᵢ(t) denotes an integrated value of earned rewards of the task i up to the preceding block of the block to which the round t belongs, and A (in Formula (2), A is indicated by an illuminated letter) denotes a set of combinations of tasks executable in parallel in the same round.

### (Supplementary Note 4)

The scheduling apparatus according to any one of Supplementary notes 1 to 3, wherein the selection means calculates a block length of each block by using a lower bound and an upper bound C of a required round count of each task.

### (Supplementary Note 5)

The scheduling apparatus according to Supplementary note 3, wherein the selection means calculates a block length bs of each block s in accordance with the following Formula (3).

$${b}_{s} = \underline{C} {min}_{i ∈ {A}_{s}^{′}} {N}_{i} ( t ) + \overline{C} \qquad ( 3 )$$

### (Supplementary Note 6)

A scheduling method including: an obtaining process of obtaining, by at least one processor, an earned reward and a required round count of a task that completes execution in a round; and
a selection process of selecting, by the processor, a combination of tasks each starting execution in a round with reference to the earned reward and the required round count obtained in the obtaining process,
in the selection process, the processor dividing a set of rounds into a plurality of blocks and selecting the combination of tasks each starting execution in each of the rounds such that a combination of the same tasks is executed in each of rounds belonging to the same block.

### (Supplementary Note 7)

A scheduling program causing at least one processor to function as:
obtaining means for obtaining an earned reward and a required round count of a task that completes execution in a round; and
selection means for selecting a combination of tasks each starting execution in a round with reference to the earned reward and the required round count obtained by the obtaining means,
the selection means dividing a set of rounds into a plurality of blocks and selecting the combination of tasks each starting execution in each of the rounds such that a combination of the same tasks is executed in each of rounds belonging to the same block.

### [Additional Remark 3]

Furthermore, some of or all of the above example embodiments can also be expressed as below.

### (Supplementary Note 8)

A scheduling apparatus including at least one processor, the processor carrying out:
an obtaining process of obtaining an earned reward and a required round count of a task that completes execution in a round; and
a selection process of selecting a combination of tasks each starting execution in a round with reference to the earned reward and the required round count obtained in the obtaining process,
in the selection process, the processor dividing a set of rounds into a plurality of blocks and selecting the combination of tasks each starting execution in each of the rounds such that a combination of the same tasks is executed in each of rounds belonging to the same block.

Note that the scheduling apparatus may further include a memory, which may store therein a program for causing the at least one processor to carry out the obtaining process and the selection process. Alternatively, the program may be stored in a computer-readable, non-transitory, tangible storage medium.

### REFERENCE SIGNS LIST

1 Scheduling apparatus
11 Obtaining section (obtaining means)
12 Selection section (selection means)
S1 Scheduling method
S11 Obtaining process
S12 Selection process

What is claimed is:

1. A scheduling apparatus comprising at least one processor, the at least one processor carrying out:
an obtaining process of obtaining an earned reward and a required round count of a task that completes execution in a round; and
a selection process of selecting a combination of tasks each starting execution in a round with reference to the earned reward and the required round count obtained in the obtaining process,
in the selection process, the at least one processor dividing a set of rounds into a plurality of blocks and selecting the combination, wherein a combination of the same tasks is executed in each of rounds belonging to the same block.

2. The scheduling apparatus according to claim 1, wherein, for each block, in the selection process, the at least one processor (i) calculates an estimated reward of each task by using a lower confidence bound (LCB) of an average required round count of the task and an upper confidence bound (UCB) of an average earned reward of the task, and (ii) selects a combination of tasks that maximizes a sum of estimated rewards of the tasks, from among combinations of tasks executable in parallel in the same round, as a combination of tasks to be executed in the block.

3. The scheduling apparatus according to claim 2, wherein, for each block s, in the selection process, the at least one processor (i) calculates an estimated reward qᵢ(t) of each task i in accordance with the following Formula (1), and (ii) selects a combination A's of tasks to be executed in the block s in accordance with the following Formula (2):
$${\hat{c}}_{i} ( t ) = \frac{{C}_{i} ( t )}{{N}_{i} ( t )} , {\hat{r}}_{i} ( t ) = \frac{{R}_{i} ( t )}{{N}_{i} ( t )} , \\ {d}_{i} ( t ) = \sqrt{\frac{2 log t}{{N}_{i} ( t )}} , {q}_{i} ( t ) = \frac{{r}_{i} ( t ) + {d}_{i} ( t )}{max \{ {\underline{C}}_{i} {\hat{c}}_{i} ( t ) - \overline{C} {d}_{i} ( t ) \}} \qquad ( 1 )$$
$${A}_{s}^{′} ∈ {arg max}_{A ∈ 𝒜} {\sum }_{i ∈ A} {q}_{i} ( t ) \qquad ( 2 )$$
in which C₋ (in Formula (1), − is written under C) denotes a lower bound of a required round count of the task i, C⁻ (in Formula (1), − is written over C) denotes an upper bound of the required round count of the task i, Nᵢ(t) denotes the number of times the task i completes execution before or during a preceding block of a block to which a round t belongs, Cᵢ(t) denotes an integrated value of the required round count of the task i up to the preceding block of the block to which the round t belongs, Rᵢ(t) denotes an integrated value of earned rewards of the task i up to the preceding block of the block to which the round t belongs, and A (in Formula (2), A is indicated by an illuminated letter) denotes a set of combinations of tasks executable in parallel in the same round.

4. The scheduling apparatus according to claim 1, wherein in the selection process, the at least one processor calculates a block length of each block by using a lower bound and an upper bound of a required round count of each task.

5. The scheduling apparatus according to claim 3, wherein in the selection process, the at least one processor calculates a block length bs of each block s in accordance with the following Formula (3).
$${b}_{s} = \underline{C} {min}_{i ∈ {A}_{s}^{′}} {N}_{i} ( t ) + \overline{C} \qquad ( 3 )$$

6. A scheduling method comprising:
an obtaining process of obtaining, by at least one processor, an earned reward and a required round count of a task that completes execution in a round; and
a selection process of selecting, by the processor, a combination of tasks each starting execution in a round with reference to the earned reward and the required round count obtained in the obtaining process,
in the selection process, the processor dividing a set of rounds into a plurality of blocks and selecting the combination, wherein a combination of the same tasks is executed in each of rounds belonging to the same block.

7. A computer-readable non-transitory storage medium storing a program for causing a computer to function as the scheduling apparatus according to claim 1, the program causing the computer to carry out the obtaining process and the selection process.
